(19) United States
(12) Patent Application Publication
(10) Pub. No.: US 2015/0352582 A1
(43) Pub. Date: Dec. 10, 2015

(54) Cleaning of nozzles from solidified coating materials

(71) Applicant: Burkhard Büstgens, GUNDELFINGEN (DE)

(72) Inventor: Burkhard BÜSTGENS, GUNDELFINGEN (DE)

(21) Appl. No.: 14/734,134

(22) Filed: Jun. 9, 2015

Related U.S. Application Data
(60) Provisional application No. 62/009,937, filed on Jun. 10, 2014.

(51) Int. Cl. B05B 15/02; B08B 9/032; B08B 7/02

(52) U.S. Cl. CPC B05B 15/0241; B08B 7/02; B08B 9/0321; B05B 15/025

(57) ABSTRACT

A method for cleaning a nozzle of a multi-nozzle Drop-on-Demand coating head from solidified coating material, which adheres at the surface of the nozzle, characterized in, that the nozzle is deformed up to an extent, that adhesion forces between solidified coating material and nozzle surface are overcome and thus the solidified coating material is detached from the surface of the nozzle, and, that the detached solidified coating material is flushed out of the nozzle by means of the liquid coating material.

The invention relates to the field of contactless coating of surfaces or bodies with liquid coating materials, in the following also referred to as coating material or material, which solidifies on the surface or body and thereby results in a durable coating.

The inventive teaching is applicable in the entire conventional inkjet printing and the related fields, however particularly relates to the field of coating surfaces or bodies with material in layer thicknesses of up to 1 mm by Drop-on-Demand printing technology. In the field of coating technology here, coating of surfaces with materials such as emulsion paints or varnishes in the Drop-on-Demand technology is of paramount importance, as described in U.S. Pat. No. 8,556,373. In particular, the invention also relates to the field of generic production or 3D-printing, because even here binder containing, quick-drying or cross-linking liquid materials are printed, with the help of which, three-dimensional body additives are made.

The conventional coating materials in the coating technology have pigments, fillers, binders and additives and are configured for a quick drying of the coatings, which causes the problem of drying up or hardening of material in the nozzles of the DOD coating head, i.e. solidified material accumulates on the inner surfaces of the nozzles and finally blocks these. Small accumulations can lead to affect the delivery quantity and to the diversion in the trajectory of the droplets. Since the process of the material accumulations is not completely unavoidable, the nozzles of a DOD coating head must be flushed at short intervals, which requires a certain device-related expenditure and time. A simpler, integrated and time-saving option of removing the accumulations during a continuous operation would be desirable.

Therefore, the object of the invention is to propose a simple method for cleaning of DOD-nozzles from adhering, solidified coating material, preferably without any significant interruptions of a continuous operation.

The object is achieved by the preamble and the features of claim 1. Accordingly, a method is envisaged for cleaning the nozzle of a Drop-on-Demand coating head from solidified coating material, characterized in that the nozzle is deformed in order to remove solidified coating material, which adheres to the nozzle, and that the removed coating material along with the liquid coating material is carried out of the nozzle.

The invention discloses methods and devices for removing the solidified coating material adhering in the nozzle by deforming the nozzle, wherein the nozzle is made of an elastic material, for example an elastomer.

The invention discloses methods and devices for deforming the contour of the inner nozzle surface, i.e. for local changes in the surface curvature or for stretching or compressing the inner nozzle surface, so that the adhering material is removed.

Furthermore, the invention discloses the use of Silicon as nozzle material with low surface-energy. Thereby, only a little adhesion between the nozzle and solidified material results, so that these are easily removed from each other by the deformation of the nozzle. Simultaneously, the low surface-energy of Silicon ensures an effective removal of droplets of the escaping liquid coating material.

The invention discloses hydraulic and mechanical methods and devices based on the application of ultrasound for deforming the nozzle.

The hydraulic cleaning process takes advantage of the fluid pressure of the liquid coating material itself, which is developed on the nozzle with the droplets discharge in order to deform the nozzle. Simultaneously, the solidified coating material so removed is evacuated through the nozzle. Thus, the nozzle is cleaned by each droplet discharge.

The mechanical cleaning process relies on the effects of mechanical elements, such as force transmission elements or plates on a respective elastomer insert of a nozzle and in this manner, cause the deformation of the inner contour of the nozzle. In a particular embodiment, the mechanical element, which causes the deformation of the elastomer nozzle, is also a nozzle closing element. Therefore, apart from closing the nozzle, this also has the function of deforming the nozzle during opening and closing the nozzle. Thereby, the common principle of closing a solid nozzle with an elastic sealing element is reversed here: In accordance with the invention, an elastic, deformable nozzle is closed by a solid, non-deformable cover plate. Generally speaking: a force transmission element, which is used for deformation of the nozzle, is also used for closing the nozzle. Therefore, simultaneously the deformation of the nozzle is achieved, which removes the adhering solidified material. In accordance with the invention, a force transmission element can perform swinging movements for loosening the adhering material; similarly a fluid pressure can have a periodic time characteristic in order to likewise loosen the material adhering on the nozzle surface in the same manner.

The ultrasound-based cleaning method uses sound vibrations in order to deform the inner contour of the nozzle and thereby to affect the removal of the coating material adhering to the nozzle. Two embodiments are proposed here in accordance with the invention.

The invention discloses hydraulic actions for flushing out the removed, solidified coating material from a pressure nozzle 2 by means of liquid coating material.

By cleaning the nozzle from adhering solidified material according to the method in accordance with the invention, the reliability, lifespan and operational efficiency of the DOD coating head can be substantially increased. The method in accordance with the invention offers particular advantages during printing of binder containing, particle containing and quick-drying or quick-hardening coating materials.

In the following, the invention is described in details, see the figures: Coating means, coating material or simply material: Here, material is referred to every liquid substance or every mixture of liquid substances, which can transform into a solid material after a chemical, biological or physical solidification method and can form a layer or structure on a substrate or a body. Examples include: particle containing, intrinsically viscous, binder containing, physical (including UV) or chemically cross-linked, two or more component systems, for example, on epoxy or polyurethane based or specific monomers: colours, varnishes, emulsions, dry and overall dimensions, cements, gypsum, pastes, gels, glues, liquid foodstuff and much more.

Within the scope of the invention, a Drop-on-Demand (DOD) coating head consists of devices for electrically driven production of droplets, clouds of droplet or transient jets of liquids, which are discharged by nozzles, fluid outlets or openings, simply referred to as “Nozzles” here, in a contactless manner on a substrate or body. A DOD coating head should generally include inkjet heads, jet valves or printing heads. In the coating process, the material is discharged in liquid form from one or more nozzles, contactless “micro dosing” also refers to small droplet volumes.

Examples for generic coating heads are outlined in FIG. 1a and FIG. 1b. Normally, these have a plurality of nozzles, or in other words, electrically driven individual channels or groups of channels. FIG. 1a illustrates in a sectional view, a DOD coating head with its housing 1, which operates according to valve principle. Liquid material is supplied to the inlet 4 under pressure pFL and the nozzle 2 is operated by a quick operating fluid valve at the outlet. In the outlined example, the valve is made of a rotationally symmetrical closing element 5, which keeps the intermediate fluid passage close or releases it in interaction with a valve seat 6 as part of the housing. The closing element 5 and valve seat 6 form a fluid passage with optimum low fluid resistance in the opened condition. Closing element 5 and/or valve seat 6 can be made of an elastomer in order to achieve an improved sealing effect. The closing element 5 is lifted-off the valve seat 6 for opening the valve by means of an actuation device, in this case by a pneumatic membrane actuator, which is actuated as a function of the difference of the pneumatic control pressure ppneu and the fluid pressure pFL. Exemplarily, the solidified material 3 is represented in the nozzle.

### DESCRIPTION OF THE DRAWINGS

FIG. 1a and FIG. 1b show an exemplary embodiment of a generic DOD coating head 1.

FIG. 2a, FIG. 2b1, FIG. 2b2 and FIG. 2c illustrate the steps according the method of the invention.

FIG. 3a, FIG. 3b, FIG. 3c and FIG. 3d show different embodiments of elastomeric nozzles integrated as elastomeric inserts into the housing.

FIG. 4a, FIG. 4b, FIG. 4c, FIG. 4d and FIG. 4e show further embodiments of elastomeric nozzles integrated as elastomeric inserts into the housing.

FIG. 5a, FIG. 5b, FIG. 5c, and FIG. 5d illustrate various methods to deform nozzles by means of mechanical force.

FIG. 6a and FIG. 6b show two embodiments to deform nuzzles by means of sound waves.

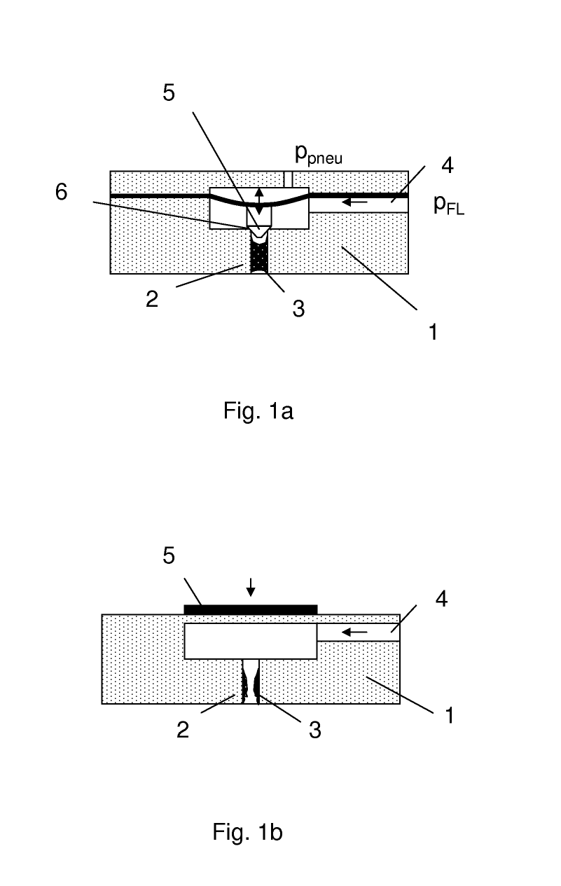

FIG. 1b shows the exemplary embodiment of a generic DOD coating head 1, which operates according to the inkjet principle. A piezo-bending actuator 5 made from a disc of piezoelectric material and a wall of the housing 1, bends while applying an electric voltage at the piezo-disc in the fluid chamber and thus reduces its volume for a fraction of a millisecond and throws a drop of material out of the opening 2. By releasing the actuator, the material is sucked in through the inlet 4, driven by the capillary pressure in nozzle 2.

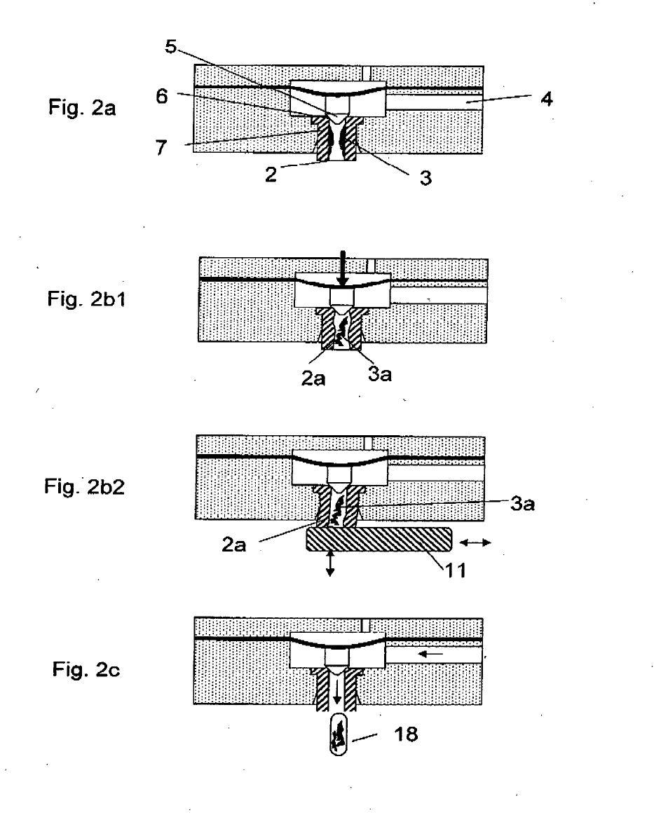

In order to remove the solidified coating material 3 in a nozzle 2, see FIG. 2a, the nozzle is deformed in accordance with the invention and the removed coating material is carried away out of the nozzle by means of liquid coating material. However, generally this does not necessarily occur during the droplet discharge. In FIG. 2a, a DOD coating head is, outlined, which operates according to the jet valve principle. Since the elastic characteristic should be present only in the region of the nozzle 2 and the entire housing 1 should not be elastic, the nozzles 2 in accordance with the invention are preferably configured as elastomer insert. Elastomer inserts can be produced either inserted into the housing 1 or for example, they are produced in a multi-component injection-moulding process or other integrated manufacturing processes. In the present example, the elastomer insert 7 encloses the nozzle 2 as well as the valve seat 6, which is thereby elastic and achieves an effective sealing effect on interaction with the closing element 5, which can be made of a solid non-elastomer material. Therefore, nozzles 2 in accordance with the invention are enclosed in an elastomer insert 7, which is embedded in the housing 1.

Solidified coating material 3 adhering on the wall surfaces of the nozzle 2 is located in the elastomer nozzle 2, see FIG. 2a. In accordance with the invention, the nozzle is deformed by a force or pressure. The case FIG. 2b1 represents that the closing element 5 exerts a force on the valve seat 6, which is located in the elastomer insert 7. Therefore, the deformation of the nozzle so caused is a function of the contact pressure of the closing element 5 7 on the valve seat 6 and the length and diameter of the elastomer insert 7 and the nozzle 2. In accordance with the invention, the above-mentioned parameters are configured such that a sufficient deformation of the nozzle 2 is still exists at the outlet thereof. In addition to the static deformation, the dynamic deformation of the valve seat 6 also has an effect in the exemplary embodiment shown, which occurs as a result of the transfer of momentum of the closing element 5 to the valve seat 6. Thus, vibrations occur with the impacts of the closing element 5 on the valve seat 6, which spread as surface waves (surface acoustic waves) into the nozzle 2, also see the FIG. 2b1. The solidified coating material removed by deformation of the nozzle 2 along with the liquid coating material is then carried out towards the nozzle during the next opening of the fluid valve under pressure, see drops 18 in FIG. 2c. Since the cleaning method in accordance with the invention described here is carried out at every single fluid discharge, the method in accordance with the invention is perfectly suitable in order to achieve permanently high process reliability during the Drop-on-Demand application of the quick-setting coating materials.

The case of FIG. 2b2 represents that a force is exerted from outside on the elastomer nozzle 2 or the elastomer insert 7. For this purpose, the nozzle 2 protrudes out of the housing 1 by a certain extent, for example 0.5 to 5 times the nozzle diameter, so that this can be deformed by a plate, a scraper or by hand. Normally, few movements or deformations are sufficient in order to completely remove the adhering solidified coating material from the inner walls of the nozzle 2. As FIG. 2b2 represents, a plate which is used for closing the nozzle can be brought in contact with the nozzle 2, such that the nozzle is highly deformed in the closed condition. Therefore, the plate can be laterally moved over the nozzle or can be pressed perpendicular to the opening of the nozzle 2 by a slider mechanism. In the example given, the cover 11 is used for the purpose of closing the nozzle 2 in a short or long term operational interruption. In particular, with longer storage, due to incomplete gas tightness of the nozzle and plate material or with incomplete sealing between nozzle 2 and plate 11, the coating material can dry up on the inner walls of the nozzle 2. Therefore, it acquires the contours of the nozzle 2 deformed by the plate 11. After opening the nozzle 2 by removing the plate 11, the nozzle shape again returns to its (original) shape in the released condition, whereby the adhering coating material is removed from the nozzle 2. In accordance with the invention, it is irrelevant whether the deformation takes place from a deformed condition of the elastomer nozzle into the released condition or vice-versa. Therefore, a cover 11, which seals the nozzle 2 from the surroundings, is configured such that it deforms the nozzle 2 in the closed condition.

The options FIG. 2b1 and Fi. 2b2 of deformation of the nozzle 2 or polymer element 7 superimpose in the configuration shown, therefore two deformation effects act simultaneously in order to remove the adhering solidified coating material from the inner walls of the nozzle 2.

In accordance with the invention, the solidified coating material removed by the deformation of the nozzle 2 is carried away by a liquid discharge momentum, for example with a subsequent opening of the fluid valve, or with a fluid impact in case of the inkjet head. Therefore, the solidified material is transported under pressure out of the nozzle. Occasionally, the nozzles should be actuated (launched) several times, until they are free from solidified material.

It may be advisable to introduce a cleaning cycle, which is implemented at regular intervals or after the storage: It is characterized by the positioning of a waste container before the openings of the nozzle 2, by removing solidified material from the inner surfaces of elastic nozzle 2 by means of one or several deformations of the same, and by one or multiple actuations (launchings) of the nozzle for ejecting the removed solidified material into the waste container. All this can be repeated several times on the whole. Instead of the waste container, in accordance with the invention, a half-open or closed channel system with optional (circulating) flushing system can also be used, which is part of the nozzle covering mechanism, which includes the cover plate 11.

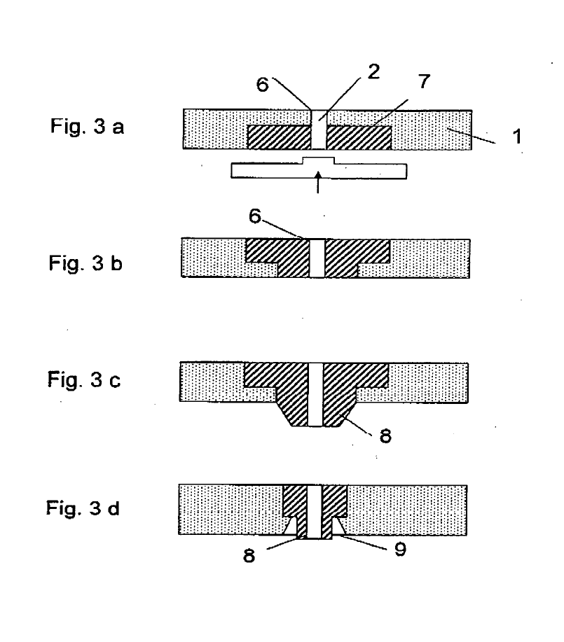

FIG. 3a-FIG. 3d shows several embodiments of nozzles 2 or elastomer inserts 7. In FIG. 3a, an elastomer insert 7 is represented, which encloses only a part of the overall nozzle length, particularly enclosing the nozzle outlet. It ends the outlet side plan with the housing 1. In order to deform it, a body should be pressed on the outlet side by means of an accentuation on the elastomer insert in the region of the outlet of the nozzle 2. The valve seat 6 is located in the housing 1.

In FIG. 3b, an elastomer insert 7 is represented, which is embedded staggered in the housing 1, and which contains the valve seat 6.

An elastomer insert with an elongated part 8 protruding out of the housing 1 is represented in FIG. 3c. The elongated part can be highly deformed from outside with little effort. According to the application, the typical nozzle diameters are between 0.05 mm and 0.5 mm, the nozzle lengths between 0.2 mm and 10 mm, the wall thicknesses of the polymer insert between 0.3 mm and 5 mm. The nozzle outlined protrudes by about 0.2 to 3 mm. Further, nozzles can have slight concentricity inside, for example with an opening angle of 0.5 to 5°. If the concentricity is opening towards the outlet, then this favours the removal and in particular, the evacuation of the removed coating material. Alternatively, the concentricity can also be opening inwards. Should the nozzle protrude out of the housing 1 only a little, the free length not connected to the housing 1 can nevertheless be more in order to achieve a high deformation of the elastomer insert 7, then a recess 9 can be provided in the housing 1, see FIG. 3d.

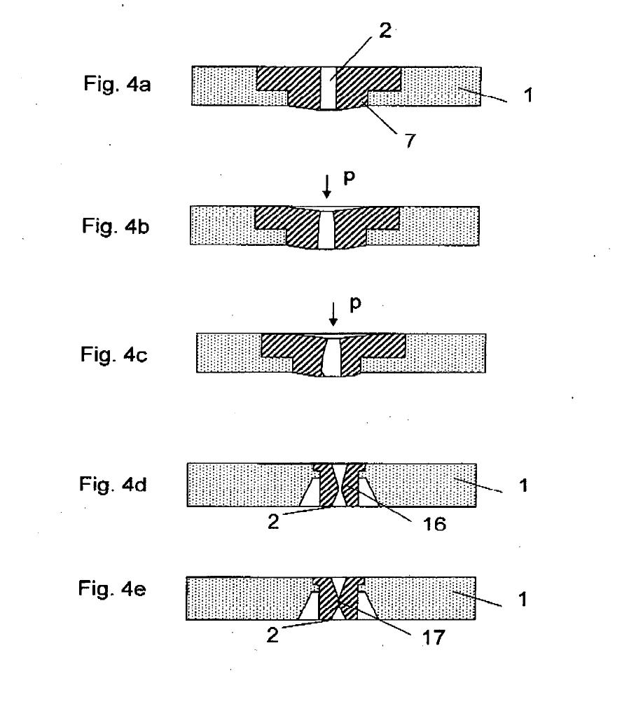

In accordance with the invention, the deformation of the elastomer insert 7 and the nozzle 2 in case of the inkjet head according to FIG. 1b can also take place by the actuation pressure pulse, which causes the droplet discharge. The liquid pressure during the launching of a drop can assume a short-term value of a few bars. In FIG. 4a, an elastomer insert of one such DOD coating head is represented in the unpressurized condition. In FIG. 4b, axial deformation of the nozzle 2 is mainly represented magnified by the increased inlet side pressure p on the nozzle 2 during launching. Since in an axial deformation of the nozzle in case of a rotationally symmetrical elastomer insert 7, only a little deformation of the contour of the hole itself occurs, a rotationally non-symmetrical shape of the elastomer insert is suggested. In FIG. 4c, a rotationally non-symmetrical deformation of the nozzle 2 of a rotationally non-symmetrical elastomer insert 7 is represented qualitatively after applying the pressure p on one side. Occasionally, a single fluid impact is sufficient in order to remove the solidified material and to eject it out of the nozzle. Since the pressure from the upper end of the nozzle spreads along the nozzle hole 2 and therefore the deformation of the nozzle 2 similarly starts from the upper end, the solidified material is removed and is completely or partially expelled out during one or several droplet impacts.

FIG. 4d shows another embodiment of an elastic nozzle 2 in accordance with the invention. In addition, a reduction in cross-section or constriction 16 is included along the fluid path within the nozzle. This can be at the nozzle inlet, at a position between the nozzle inlet and nozzle outlet, as represented in FIG. 4d, or at the nozzle outlet. The cross-section of the constriction in the unloaded condition can be round, oval, flat, star-shaped, or can be in any other rotationally symmetrical or mirror symmetrical shape. With the occurrence of a pressure surge in a droplet discharge at the nozzle inlet, a stagnation pressure develops at the constriction 16, which induces an efficient elongation of the nozzle 2 in the form of an increase in cross-section, which can also cause elongations in the remaining regions of the nozzle 2. Therefore, the shape of the cross-sectional area can substantially change, for example, a flat, oval shape can be converted into a round shape. The continuation of the principle of constricting the cross-section leads to configuration as shown in FIG. 4e, in which the cross-section is zero in an unloaded condition, so the nozzle is closed and the cross-section expands only with an input side minimum pressure pmin to such an extent that an open flow-through cross-section results. In the unloaded condition, such a cross-section is produced, for example in a stage, i.e. a material separation without material removal. At the pressurized side of the nozzle inlet, the loaded condition, the cross-section opens such that an approximately oval shape results. In another variant, there are two or more stages, whereby for example, the main foci of the stages coincide and a star-shaped cross-section results in the pressurized loaded condition.

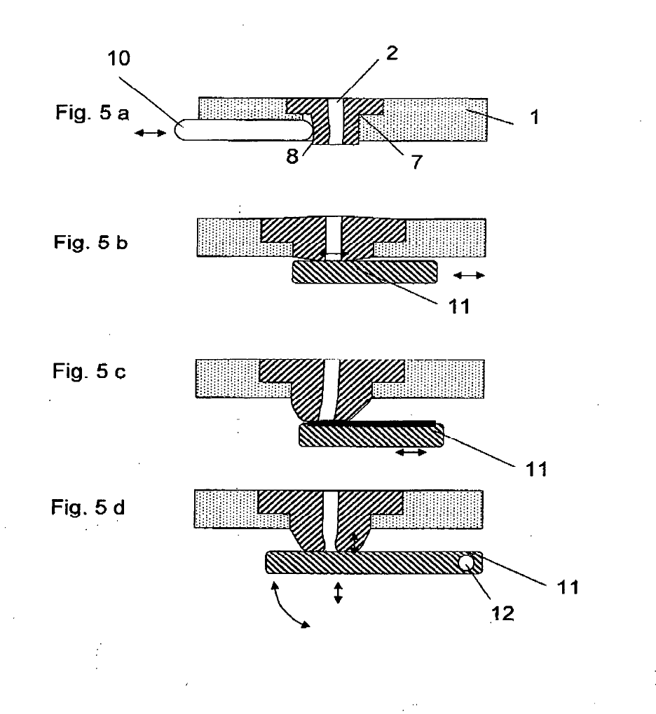

In the following, the deformation of the nozzle 2 in the elastomer insert 7 will be discussed in detail: In FIG. 5a-FIG. 5d, embodiments of elastomer inserts 7 with elements 10 for deforming the same are plotted. In FIG. 5a, an elastomer insert 7 is represented, which is deformed by means of a movable deforming element in the shape of a bolt radially disposed with respect to the nozzle. In this manner, very high deformations are produced and a strong effect is achieved for separating the solidified coating material from the walls of the nozzle 2. The elastomer insert according to FIG. 5b has a very flat cone with central nozzle outlet on the outer surface of the nozzle, which is deformed, when a cover 11, e.g. a plate is moved laterally on the surface of the housing 1 and brought in alignment with the opening of the nozzle. FIG. 5c illustrates the resulting deformation of the nozzle 2 and the elastomer insert 7 in case of another nozzle shape protruding out of the housing 1 in case of a deformation by a slider 11 movable laterally with respect to the housing 1. The slider coating on the area of contact with the nozzle is represented. Hydrophobic materials, such as fluoropolymers, particularly PTFE, PFA or FEP can be used for coating in

order to prevent adhesion of the coating material. Elastomers, particularly Silicons are more advantageous because of their similar low surface energy. The deformation of the construction in FIG. 5d is qualitatively similar to that in FIG. 5c, however in case of a closing movement of the cover 11 in the direction of the nozzle axis, as this is the case by a rotation about the fulcrum outlined.

For removing the adhering solidified material, it is essential that in deforming the nozzle, the adhesion forces between the material and nozzle wall surfaces are overcome, for example, which can be easily achieved by using an elastomer nozzle material with low surface energy, such as Silicon. Furthermore, it is favourable if the elastomer of the nozzle has a higher elasticity or lower hardness than the adhering solidified material. Therefore, in accordance with the invention, the deformation of the nozzle in the region of contact surface with the adhering solidified coating material, i.e. on the inner contour of the nozzle is to be carried out to such an extent that the shear forces acting on the inner nozzle wall surfaces due to deformation overcome the adhesion forces between the material and nozzle wall surface.

Furthermore, the material of the elastomer insert 7 is substantially more elastic than housing 1. However, it has a high Shore hardness, preferably of 70-90, more preferably 80-90, therefore the mechanical stability of the nozzle 2 sufficient for droplet ejection is ensured. Further, the material is preferably only elastically deformed by the deformation, i.e. the deformation should not be carried out up to the plastic, irreversible region as far as possible, because the material fatigue would occur as a result. Examples for further useful elastomers are FFKM, NBR, EPDM, FKM/FPM, Urethane and many more.

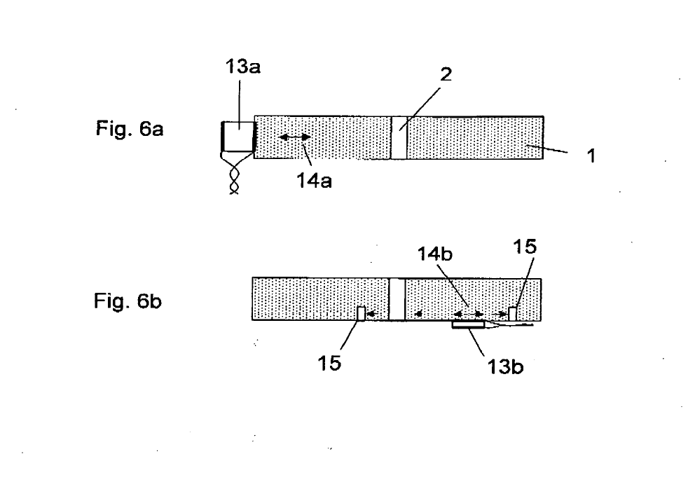

In another variant in accordance with the invention, the deformation of the nozzle 2 is achieved with the help of ultrasound, which is emitted from the ultrasonic transducers mounted on the housing 1. On the basis of FIG. 6a and FIG. 6b, two possible configurations will be described: FIG. 6a shows a first embodiment in accordance with the invention. A piezo-crystal 13a is used as an acoustic transducer, which is laterally mounted on the housing 1. The piezo crystal has electrodes on opposite faces, which are supplied with an alternating (AC) voltage. The piezo-crystal 13a is glued to the housing 1 by one of the electrodes. At high frequencies in the MHz range, mainly longitudinal waves 14a in the housing 1 are emitted in radial direction with respect to the nozzle. Therefore, the piezo-crystal in the example shown is operated in (3,3) mode. In accordance with the invention, even here the deformation of the nozzle 2 is involved in the removal of the adhering solidified coating material from the nozzle surface. Therefore, the deformation is an integral function of the sound velocity at the nozzle location.

Since longitudinal waves in solid bodies are transmitted with high radiation impedance, the wave energy mainly manifests in high acoustic pressure instead of high sound velocity. The use of surface waves is more favourable, for example Rayleigh waves, since these enable a significantly higher material deformations based on their much lower (according to the amount) radiation impedance. This case is outlined in FIG. 6b. A flat piezo-crystal is glued to one of its two active electrodes on the nozzle outlet side of the housing 1 and is electrically driven by an alternating signal in the MHz range. The crystal is flat in shape and is driven in (3,1) direction, i.e. induced perpendicular to the electrode surface (3-Directional), while the elongation of the crystal caused by the transversal contraction parallel to the electrodes (Unidirectional) is used (Unidirectional) for generating ultrasound. Therefore, shear vibrations are transmitted to the housing via the adhesive layer. According to the frequency, these spread primarily along the surface until they come across an edge, which represents an abrupt change in acoustic impedance and causes a reflection of the wave according to the law of sound propagation. In the example shown, two grooves 15 are shown, at which the surface waves are respectively reflected back, thus the wave travels back and forth between them. In this case, a housing corner is acoustically equivalent to a groove, which is why both are generally referred to as reflection points. It is useful if the distance of the reflection points is a multiple of one half-wavelength of the surface wave, since higher sound velocities and material elongations can be achieved at periodic, particularly harmonic signal path of the excitation by superimposition. Therefore, a reflection point need not be configured compulsorily as straight corner or edge. Even round or parabolic shapes of grooves are possible, which cause the reflection of incident waves towards one or more focal points, which are particularly one or more nozzle openings. Therefore, in accordance with the invention, the nozzle 2 is located within the acoustic field of the surface wave in case of a stationary acoustic field at the point of a maximum sound velocity, i.e. at an acoustic pressure node. This is preferably located at a distance from a multiple 1 . . . n of one half-wavelength of a reflection point. In accordance with the invention, the deformation of the housing material is used in the region of the nozzle 2 in order to remove adhering solidified coating material. Therefore, the deformation effect of the wave in the material is smaller with increasing distance from the surface and is approximately 1-2 wavelengths in Rayleigh waves. However, since the fastest dryings occur near the surface, this effect is not undesirable.

By reducing the frequency and reducing the housing thickness along with the nozzle length, the acoustic factors change, so that from the Rayleigh waves, the well-known Lamb-waves, which in principle corresponds to the bending wave and can be used for the method for deforming the nozzle 2 in accordance with the invention.

Another effect of the ultrasound excitation of a DOD nozzle in the region of its outlet, i.e. in the region of the nozzle outlet, according to the aforementioned method, particularly by surface waves, particularly by Rayleigh waves, is based on the cavitation of the liquid coating material. The ultrasound excitation by surface waves leads to relevant speed components in the region of the nozzle outlet along the nozzle axis and perpendicular to the face of the fluid outlet. This produces shear stress between the liquid coating material and nozzle wall, which effectively supports in loosening of drops. This method can be used in order to support the loosening of the drops from the nozzle surface, primarily in case of the DOD printing of viscous or adhesive coating materials.

1. Method for cleaning a nozzle of a multi-nozzle Drop-on-Demand coating head from solidified coating material, which adheres at the surface of the nozzle, characterized in,
that the nozzle is deformed up to an extent, that adhesion forces between solidified coating material and nozzle surface are overcome and thus the solidified coating material is detached from the surface of the nozzle, and,
that the detached solidified coating material is flushed out of the nozzle by means of the liquid coating material.

2. Method according to claim 1, wherein the nozzle is deformed by means of the pressure of the liquid coating material.

3. Method according to claim 1, wherein the nozzle is deformed by means of mechanical force.

4. Method according to claim 3, wherein the mechanical force is applied to the nozzle mainly in a radial direction of the nozzle by means of a mechanical movable element 10.

5. Method according to claim 3, wherein the mechanical force is applied by a cover 1, which seals the nozzle.

6. Method according to claim 3, wherein the nozzle is protruding from a housing thus forming a protruding part 8 of the nozzle, which is deformed by means of a force applied manually or by means of a mechanical moving element.

7. Method according to claim 1, wherein the nozzle is deformed by means of sound vibrations in order to deform the inner contour of the nozzle.

8. Drop-on-Demand droplet generator, characterized by a deformable open-jet nozzle 2 made of an elastic material, means for deforming the open-jet nozzle and means for flushing out removed solidified coating material out of the nozzle 2 by moans of liquid coating material.

9. Drop-on-Demand droplet generator according to claim 8, characterized in that nozzles 2 are enclosed in an elastomer insert 7, which is embedded in the housing 1.

10. Drop-on-Demand droplet generator according to claim 8, characterized in that the elastomer insert 7 encloses a valve seat 6 of a dosing valve.

11. Drop-on-Demand droplet generator according to claim 8, characterized by a cover 11, which seals the nozzles 2 from the surroundings and is configured such that it deforms the nozzle in the closed position.

12. Drop-on-Demand droplet generator according to claim 8, characterized in that the nozzles are out of silicone.
